(19) United States
(12) Patent Application Publication
(10) Pub. No.: US 2013/0021329 A1
(43) Pub. Date: Jan. 24, 2013

(54) DISPLAY DEVICE

(71) Applicants: Sho Sakamoto, Tokyo (JP); Yuichi Inoue, Kanagawa (JP); Kenichi Takahashi, Kanagawa (JP)

(72) Inventors: Sho Sakamoto, Tokyo (JP); Yuichi Inoue, Kanagawa (JP); Kenichi Takahashi, Kanagawa (JP)

(73) Assignee: Sony Corporation, Tokyo (JP)

(21) Appl. No.: 13/492,139

(22) Filed: Jun. 8, 2012

(30) Foreign Application Priority Data
Jul. 21, 2011 (JP) 2011-160223

(51) Int. Cl. G09G 3/36; G06T 15/00

(52) U.S. Cl. 345/419; 345/102

(57) ABSTRACT

A display device includes: a display unit respectively displaying respective pixel information of plural viewpoint images different from one another by arranging the pixel information in a circulating order in the plural viewpoint images on a display surface; and a barrier unit having plural liquid crystal barriers capable of being switched between an open state and a closed state, extending in a first direction as well as arranged side by side in a second direction intersecting the first direction, in which each barrier includes plural branch electrodes arranged side by side. A pitch “s” of the branch electrodes in the second direction satisfies the following expression (A).

Sin⁻¹(λ/s)˜θt (A)

### FIELD

The present disclosure relates to a parallax-barrier type display device capable of performing stereoscopic display.

### BACKGROUND

In recent years, a display device capable of performing stereoscopic display attracts attention. In the stereoscopic display, a left-eye image and a right-eye image having parallax to each other (different viewpoints) are displayed, which can be recognized as a stereoscopic image with depth when seen by the right and left eyes of an observer. A display device which can provide the observer more natural images by displaying three or more images having parallax to one another is also developed.

The above display devices are roughly divided into a type in which dedicated glasses are necessary and a type in which dedicated glasses are not necessary. The dedicated glasses make the observer feel annoying, therefore, the type in which the dedicated glasses are not necessary is requested. As display devices in which the dedicated glasses are not necessary, for example, there are devices of a lenticular lens system, a parallax barrier system and so on. In these systems, plural images (viewpoint images) having parallax to one another are simultaneously displayed and different images are seen according to the relative positional relationship (angles) between the display device and the viewpoint of the observer. For example, a parallax-barrier type display device using liquid crystal devices as barriers is disclosed in JP-A-3-119889 (Patent Document 1).

In a liquid crystal display (LCD) device, for example, VA (vertical alignment) mode liquid crystal is often used. For example, there is disclosed a liquid crystal display device in JP-A-2002-107730 (Patent Document 2), in which plural slits are provided in a pixel electrode to thereby allow liquid crystal molecules to be aligned in desired directions easily.

### SUMMARY

Incidentally, high image quality is generally desirable in the display device, and it is desirable to improve image quality also in the parallax-barrier type display device.

In view of the above, there is a need to provide a display device capable of improving image quality.

An embodiment of the present disclosure is directed to a display device including a display unit respectively displaying respective pixel information of plural viewpoint images different from one another by arranging the pixel information in a circulating order in the plural viewpoint images on a display surface, and a barrier unit having plural liquid crystal barriers capable of being switched between an open state and a closed state, extending in a first direction as well as arranged side by side in a second direction intersecting the first direction, in which each barrier includes plural branch electrodes arranged side by side, in which a pitch “s” of the branch electrodes in the second direction satisfies the following expression (A).

Sin⁻¹(λ/s)˜θt (A)

In the above expression, θ denotes a light wavelength transmitted through one liquid crystal barrier in the open state, and

θt denotes an angle between a line connecting one pixel arranged at a position corresponding to another liquid crystal barrier which is different from the one liquid crystal barrier in plural liquid crystal barriers in the open state to the one liquid crystal barrier and a normal direction of the display surface in a plane including the second direction and the normal direction.

Another embodiment of the present disclosure is directed to a display device including a display unit respectively displaying respective pixel information of plural viewpoint images different from one another by arranging the pixel information in a circulating order in the plural viewpoint images on a display surface, and a barrier unit in which plural transmitting portions which transmits light and plural blocking portions which blocks light are arranged side by side, in which light relating to one viewpoint image in the plural viewpoint images which is a first light emitted from a pixel arranged at a position corresponding to one transmitting portion in the plural transmitting portions and transmitted through the one transmitting portion bends along a direction in which a second light relating to the one viewpoint image travels straight, which is emitted from a pixel arranged at a position corresponding to another transmitting portion which is different from the one transmitting portion in the plural transmitting portions and traveling straight through the one transmitting portion.

In the display device according to the embodiment of the present disclosure, plural viewpoint images displayed on the display unit are viewed by an observer by allowing the liquid crystal barriers to be in the transmitting state. In the display device, the pitch “s” is set so as to satisfy the expression (A).

In the display device according to another embodiment of the present disclosure, plural viewpoint images displayed on the display unit are viewed by an observer by allowing the liquid crystal barriers to be in the transmitting state. In this case, the first light relating to one viewpoint image bends along the direction in which the second light relating to the same one viewpoint image travels straight, which is emitted from the pixel arranged at the position corresponding to another transmitting portion.

When applying the display device according to the embodiment of the present disclosure, image quality can be improved as the pitch “s” is set so as to satisfy the expression (A).

When applying the display device according to another embodiment, image quality can be improved as the first light relating to one viewpoint image bends along the direction in which the second light relating to the same one viewpoint image travels straight, which is emitted from the pixel arranged at the position corresponding to another transmitting portion and traveling straight through one transmitting portion.

### BRIEF DESCRIPTION OF THE DRAWINGS

FIG. 1 is a block diagram showing a configuration example of a 3D display device according to an embodiment of the present disclosure;

FIGS. 2A and 2B are explanatory views showing a structure example of the 3D display device shown in FIG. 1;

FIG. 3 is a block diagram showing a configuration example of a display drive unit shown in FIG. 1;

FIGS. 4A and 4B are explanatory views showing a structure example of a display unit shown in FIG. 1;

FIGS. 5A and 5B are explanatory views showing a structure example of a liquid-crystal barrier unit shown in FIG. 1;

FIG. 6 is a plan view showing a structure example of a transparent electrode layer shown in FIG. 5B;

FIGS. 7A and 7B are schematic views showing relations between the display unit and the liquid-crystal barrier unit shown in FIG. 1;

FIGS. 8A and 8B are explanatory views showing an example of arrangement of pixel information of a video signal;

FIG. 9 is a schematic view showing an operation example of the 3D display device shown in FIG. 1;

FIG. 10 is a schematic view for explaining a bending light in the 3D display device shown in FIG. 1;

FIGS. 11A and 11B are schematic views showing a display example in the 3D display device shown in FIG. 1;

FIG. 12 is a schematic view showing another display example in the 3D display device shown in FIG. 1;

FIG. 13 is a schematic view for explaining a traveling direction of the bending light in the 3D display device shown in FIG. 1;

FIG. 14 is a schematic view for explaining a bending light in a 3D display device according to a comparative example;

FIG. 15 is a schematic view showing a display example in the 3D display device according to the comparative example;

FIG. 16 is a schematic view for explaining a bending light in a 3D display device according to a modification example;

FIG. 17 is a schematic view for explaining a traveling direction of the bending light in the 3D display device according to the modification example;

FIG. 18 is a plan view showing an example of a liquid-crystal barrier unit of a 3D display device according to another modification example; and

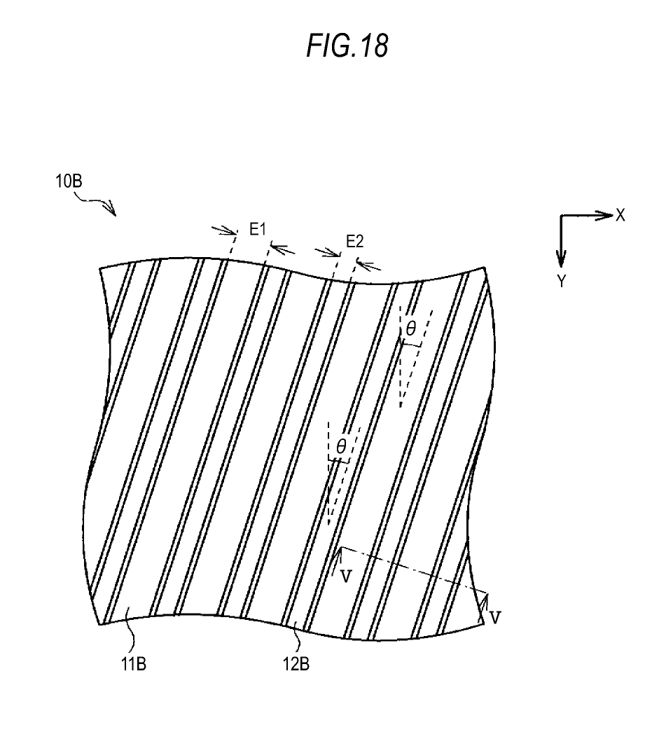

FIG. 19 is a plan view showing a structure example of a transparent electrode layer of the 3D display device according to another modification example.

### DETAILED DESCRIPTION

Hereinafter, an embodiment of the present disclosure will be explained in detail with reference to the drawings.

### Configuration Example

### Entire Configuration Example

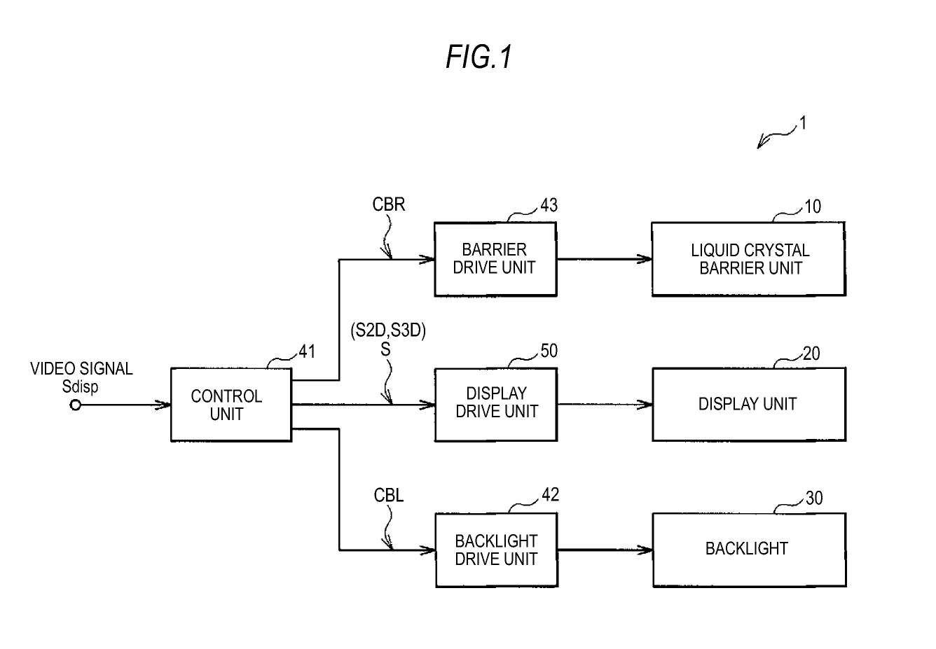

FIG. 1 shows a configuration example of a 3D display device according to the embodiment. A 3D display device 1 is a parallax-barrier type display device using a liquid crystal barrier. The 3D display device includes a control unit 41, a backlight drive unit 42, a backlight 30, a display drive unit 50, a display unit 20, a barrier drive unit 43 and a liquid-crystal barrier unit 10.

The control unit 41 is a circuit supplying control signals to the backlight drive unit 42, the display drive unit 50 and the barrier drive unit 43 respectively based on a video signal Sdisp supplied from the outside, thereby controlling these units to operate in synchronization with one another. Specifically, the control unit 41 supplies a backlight control signal CBL to the backlight drive unit 42, supplies a video signal S based on the video signal Sdisp to the display drive unit 50 and supplies a barrier control signal CBR to the barrier drive unit 43. The video signal S is a video signal S2D including one viewpoint image when the 3D display device 1 performs normal display (two-dimensional display), and is a video signal S3D including plural (five in this case) viewpoint images when the 3D display device performs stereoscopic display as described later.

The backlight drive unit 42 drives the backlight 30 based on the backlight control signal CBL supplied from the control unit 41. The backlight 30 has a function of emitting surface-emitted light to the display unit 20. The backlight 30 is formed by using a LED (light emitting diode), CCFL (cold cathode fluorescent lamp) and so on.

The display drive unit 50 drives the display unit 20 based on the video signal S supplied from the control unit 41. The display unit 20 is a liquid crystal display unit in the example, performing display by driving the liquid crystal display device and by modulating light emitted from the backlight 30.

The barrier drive unit 43 drives the liquid-crystal barrier unit 10 based on the barrier control signal CBR supplied from the control unit 41. The liquid-crystal barrier unit 10 transmits (open operation) or blocks (close operation) light emitted from the backlight 30 and transmitted through the display unit 20, including plural open/close portions 11 and 12 (described later) configured by using liquid crystal.

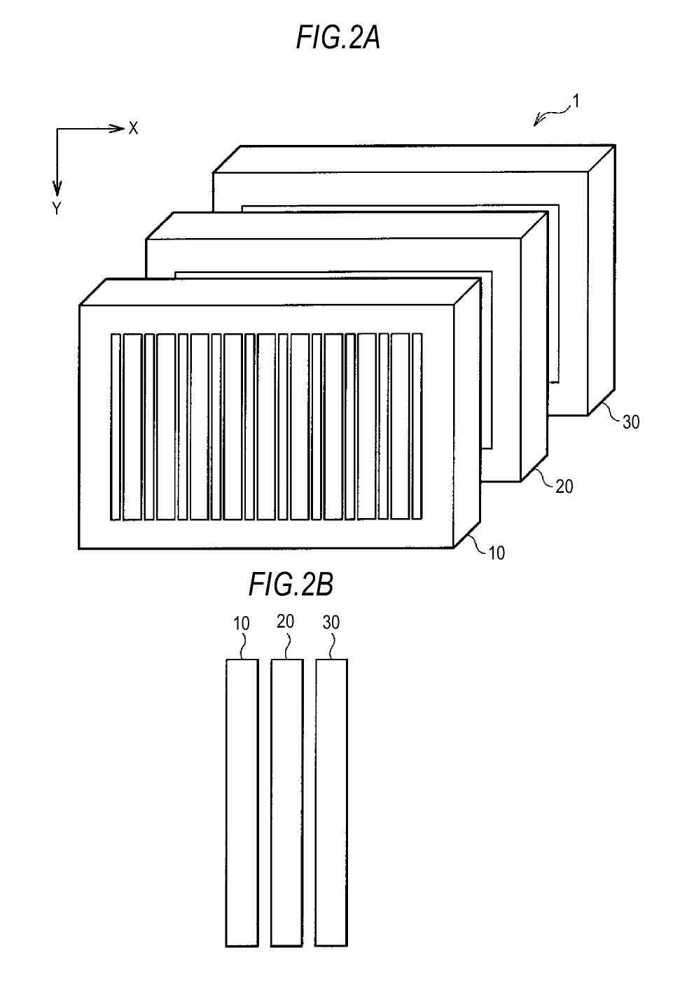

FIGS. 2A and 2B show a structure example of a relevant part of the 3D display device 1. FIG. 2A shows an exploded perspective structure example of the 3D display device 1 and

FIG. 2B shows a side surface view of the 3D display device 1. As shown in FIGS. 2A and 2B, respective components are arranged in the order of the backlight 30, the display unit 20 and the liquid-crystal barrier unit 10 in the 3D display device 1. That is, light emitted from the backlight 30 reaches the observer through the display unit 20 and the liquid-crystal barrier unit

### (Display Drive Unit 50 and Display Unit 20)

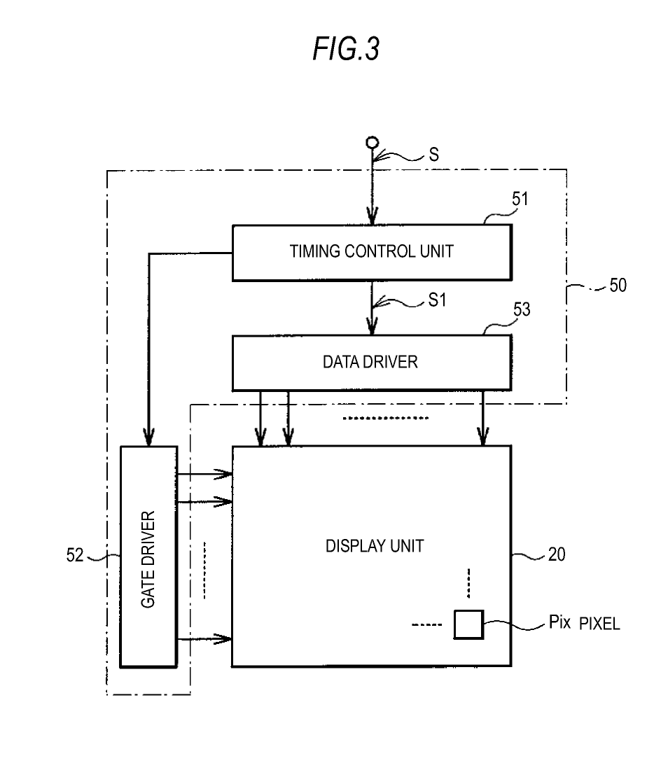

FIG. 3 shows an example of a block diagram of the display drive unit 50. The display drive unit 50 includes a timing control unit 51, a gate driver 52 and a data driver 53. The timing control unit 51 controls drive timing of the gate driver 52 and the data driver 53 as well as supplies the video signal S supplied from the control unit 41 to the data driver 53 as a video signal S1. The gate driver 52 sequentially selects pixels Pix in the display unit 20 in units of rows in accordance with the timing control by the timing control unit 51 to perform line-sequential scanning. The data driver 53 supplies a pixel signal based on the video signal S1 to respective pixels Pix in the display unit 20. Specifically, the data driver 53 performs D/A (digital/analog) conversion based on the video signal 51 to thereby generate the pixel signal as an analog signal to be supplied to respective pixels Pix.

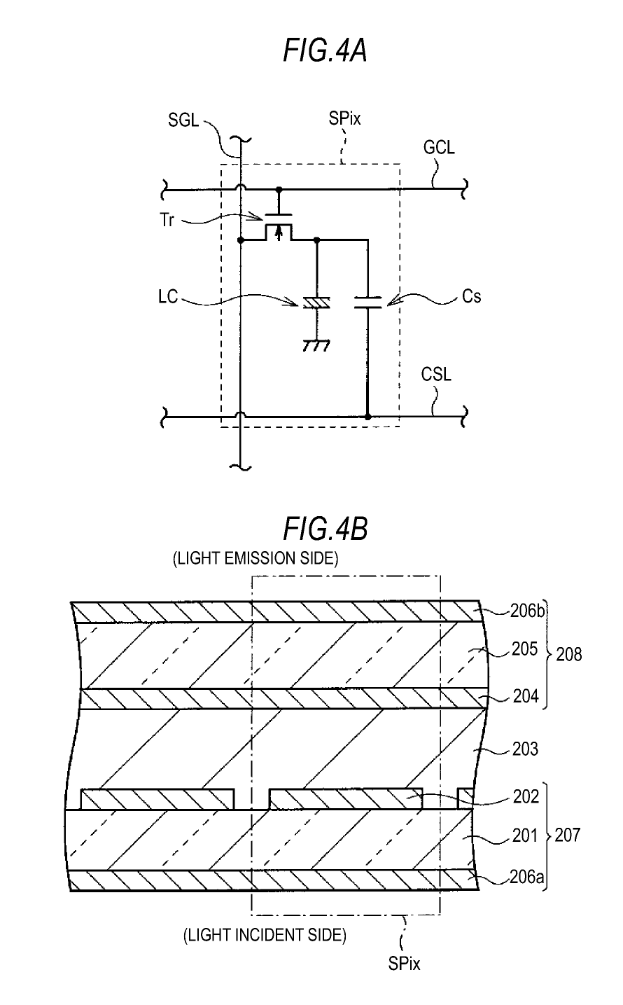

FIGS. 4A and 4B show a structure example of the display unit 20. FIG. 4A shows an example of a circuit diagram of a sub-pixel SPix included in the pixel Pix and FIG. 4B shows a cross-sectional structure of the display unit 20.

The pixel Pix includes three sub-pixels SPix respectively corresponding to red (R) green (G) and blue (B). Each sub-pixel SPix includes a TFT (Thin Film Transistor) device Tr, a liquid crystal device LC and a storage capacitor device Cs as shown in FIG. 4A. The TFT device Tr is formed by, for example, a MOS-FET (metal oxide semiconductor-field effect transistor), in which a gate is connected to a gate line GCL, a source is connected to a data line SGL and a drain is connected to one terminal of the liquid crystal device LC and one terminal of the storage capacitor device Cs. In the liquid crystal device LC, one terminal is connected to the drain of the TFT device Tr and the other terminal is grounded. In the storage capacitor device Cs, one terminal is connected to the drain of the TFT device Tr and the other terminal is connected to a storage capacitor line CSL. The gate line GCL is connected to the gate driver 52 and the data line SGL is connected to the data driver 53.

The display unit 20 is formed by sealing a liquid crystal layer 203 between a drive substrate 207 and an counter substrate 208. The drive substrate 207 includes a transparent substrate 201, pixel electrodes 202 and a polarizing plate 206a. In the transparent substrate 201, a pixel drive circuit (not shown) including the TFT devices Tr is formed. The pixel electrodes 202 are arranged in respective pixels Pix on the transparent substrate 201. The polarizing plate 206a is adhered to a face opposite to a face on which the pixel electrodes 202 are arranged in the transparent substrate 201. The counter substrate 208 includes a transparent substrate 205, a counter electrode 204 and a polarizing plate 206b. On the transparent substrate 205, not-shown color filters and black matrix are formed, and the counter electrode 204 is arranged on a face of the transparent substrate 25 which faces the liquid crystal layer 203 as an electrode common to respective pixels Pix. The polarizing plate 206b is adhered to a face opposite to a face on which the counter electrode 204 is arranged in the transparent substrate 205. The polarizing plate 206a and the polarizing plate 206b are adhered so as to be in a crossed Nicols state or in a parallel Nicols state.

### (Liquid-Crystal Barrier Unit 10 and Barrier Drive Unit 43)

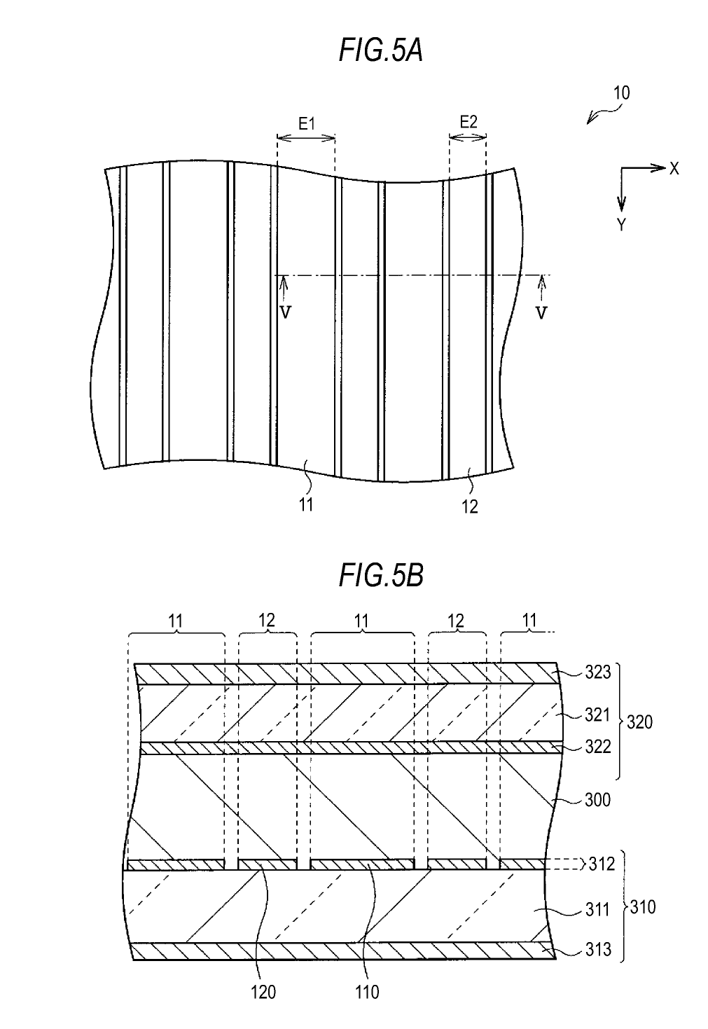

FIGS. 5A and 5B show a structure example of the liquid-crystal barrier unit 10. FIG. 5A shows a plan view of the liquid-crystal barrier unit 10 and FIG. 5B shows a cross-sectional structure taken along a direction of arrows V-V of the liquid-crystal barrier unit 10 of FIG. 5A. In the example, the liquid-crystal barrier unit 10 performs normally black operation. That is, the liquid-crystal barrier unit 10 blocks light when not being driven.

The liquid-crystal barrier unit 10 is a so-called parallax barrier, including plural open/close portions (liquid-crystal barriers) 11 and 12 which transmits or blocks light as shown in FIG. 5A. These open/close portions 11 and the open/close portions 12 are arranged so as to extend in the Y-direction in the example. In the example, a width E1 of the open/close portions 11 and a width E2 of the open/close portions 12 differ from each other and, for example, E1 is wider than E2 in this case. However, the size relation in the width of the open/close portions 11 and 12 is not limited to the above and it is also preferable that E2 is wider than E1. It is also preferable that E1 is equal to E2. These open/close portions 11 and 12 are formed by including a liquid crystal layer (later-described liquid crystal layer 300), and open/close is switched by applying a drive voltage to the liquid crystal layer 300. These open/close portions 11 and 12 perform different operations according to which operation of normal display (two-dimensional display) and stereoscopic display is performed by the 3D display device 1 as described later. Specifically, the open/close portions 11 are in an open state (transmitting state) at the time of normal display and are in a closed state (blocked state) at the time of performing stereoscopic display as described later. The open/close portions 12 are constantly in the open state (transmitting state).

The liquid-crystal barrier unit 10 includes a liquid crystal layer 300 between a drive substrate 310 and a counter substrate 320 as shown in FIG. 5B.

The drive substrate 310 includes a transparent substrate 311, a transparent electrode layer 312 and a polarizing plate 323. The transparent substrate 311 is made of, for example, glass and the like and not-shown TFTs are formed on the surface. The transparent electrode layer 312 made of, for example, ITO and the like is formed on the surface of the transparent substrate 311 which faces the liquid crystal layer 300, and a not-shown alignment layer is formed thereon. A polarizing plate 313 is adhered to a face opposite to a face on which these transparent electrode layer 312 and so on are formed in the transparent substrate 311.

The counter substrate 320 includes a transparent substrate 321, a transparent electrode layer 322 and a polarizing plate 323. The transparent substrate 321 is made of, for example, glass and so on in the same manner as the transparent substrate 311. The transparent electrode layer 322 is formed on a face of the transparent substrate 321 which faces the liquid crystal layer 300. The transparent electrode layer 322 is an electrode formed uniformly on the whole surface and is formed by a transparent conductive film such as ITO and the like, the same as the transparent electrode layer 312. A not-shown alignment film is formed on the transparent electrode layer 322. The polarizing plate 323 is adhered to a face opposite to a face on which these transparent electrode layer 322 and so on are formed in the transparent substrate 321. The polarizing plate 313 and the polarizing plate 323 are adhered so as to be in the crossed Nicols state. Specifically, for example, a transmission axis of the polarizing plate 313 is arranged in a horizontal direction X and a transmission axis of the polarizing plate 323 is arranged in a vertical direction Y.

The liquid crystal layer 300 includes liquid crystal molecules having negative dielectric constant anisotropy, which is vertically aligned by the alignment layer.

The transparent electrode layer 312 includes plural transparent electrodes 110 and 120. These transparent electrodes 110 and 120 are driven by the barrier drive unit 43. The transparent electrode layer 322 is provided as an electrode common to respective transparent electrodes 110 and 120. In the example, a common signal Vcom (DC voltage of 0V in the example) is applied to the transparent electrode layer 322 by the barrier drive unit 43. The transparent electrodes 110 of the transparent electrode layer 312 and portions corresponding to the transparent electrodes 110 in the liquid crystal layer 300 and the transparent electrode layer 322 form the open/close portions 11. Similarly, the transparent electrodes 120 of the transparent electrode layer 312 and portions corresponding to the transparent electrodes 120 in the liquid crystal layer 300 and the transparent electrode layer 322 form the open/close portions 12.

According to the above structure, when potential difference between the transparent electrode layer 312 (transparent electrodes 110 and 120) and the transparent electrode layer 322 is increased by voltage application, light transmittance in the liquid crystal layer 300 is increased and the open/close portions 11 and 12 become in the transmitting state (open state). On the other hand, the potential difference is reduced, light transmittance in the liquid crystal layer 300 is reduced and the open/close portions 11 and 12 become in the blocked state (closed state).

Though the liquid-crystal barrier unit 10 performs the normally black operation in the example, the operation is not limited to the example. It is also possible that the liquid-crystal barrier unit 10 performs normally white operation instead of the above. In this case, when potential difference of voltage applied to the liquid crystal layer 300 is increased, the open/close portions 11 and 12 become in the blocked state, and when potential difference is reduced, the open/close portions 11 and 12 become in the transmitting state.

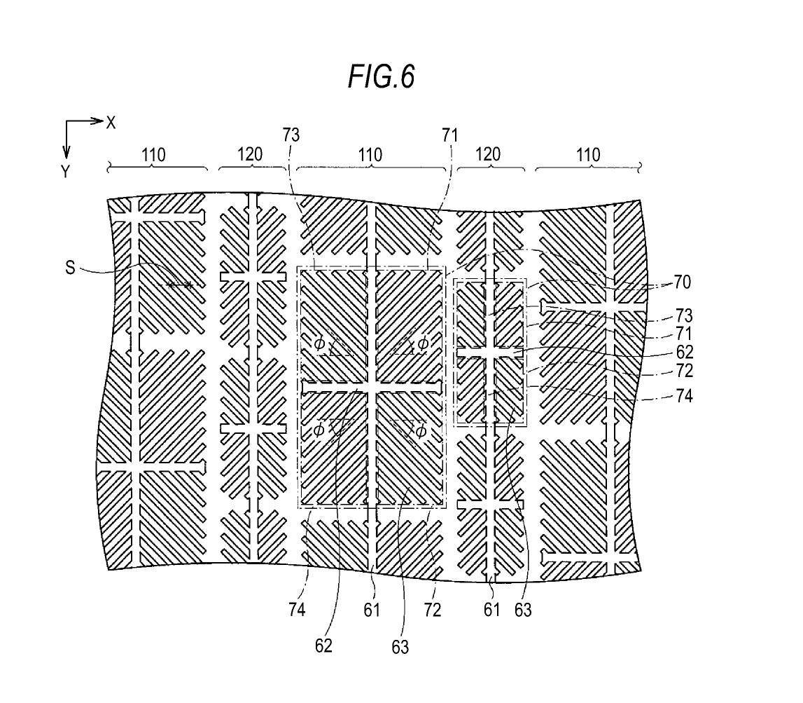

FIG. 6 shows a structure example of the transparent electrode layer 312 in the liquid-crystal barrier unit 10.

Each of the transparent electrodes 110 and 120 has a stem portion 61 extending in the same direction as an extending direction of the open/close portions 11 and 12 respectively. In the transparent electrodes 110 and 120, plural sub-electrode regions 70 are arranged side by side along an extending direction of the stem portions 61. Each sub-electrode region 70 includes a stem portion 62 and branch portions 63. The stem portion 62 is formed so as to extend in a direction intersecting the stem portion 61, namely, extend in the horizontal direction X in the example. The plural branch portions 63 arranged side by side have slits between branch portions 63 adjacent to one another. In each sub-electrode region 70, four branch regions (domains) 71 to 74 sectioned by the stem portion 61 and the stem portion 62.

The branch portions 63 are formed so as to extend from the stem portions 61 and 62 in respective branch regions 71 to 74. Line widths of the branch portions 63 are equal to one another and the slit widths are also equal to one another. The branch portions 63 extend in the same direction in respective branch regions 71 to 74. An extending direction of the branch portions 63 in the branch region 71 and an extending direction of the branch portions 63 in the branch region 73 have a line symmetrical relation with the vertical direction Y as an axis of symmetry. Similarly, an extending direction of the branch portions 63 in the branch region 72 and an extending direction of the branch portions 63 in the branch region 74 have a line symmetrical relation with the vertical direction Y as the axis of symmetry. Additionally, the extending direction of the branch portions 63 in the branch region 71 and the extending direction of the branch portions 63 in the branch region 72 have a line symmetrical relation with the horizontal direction X as the axis of symmetry, and similarly, the extending direction of the branch portions 63 in the branch region 73 and the extending direction of the branch portions 63 in the branch region 74 have a line symmetrical relation with the horizontal direction X as the axis of symmetry. In the example, specifically, the branch portions 63 in the branch regions 71 and 74 extend in a direction rotated counterclockwise from the horizontal direction X by a given angle φ, and the branch portions 63 in the branch regions 72 and 73 extend in the direction rotated clockwise from the horizontal direction X by the given angle φ. The angle φ is preferably 45 degrees.

According to the above structure, viewing angle characteristics at the time of observing a display screen of the 3D display device 1 by the observer from a left direction and a right direction can be symmetrical as well as viewing angle characteristics at the time of observation from an upper direction and a lower direction can be symmetrical.

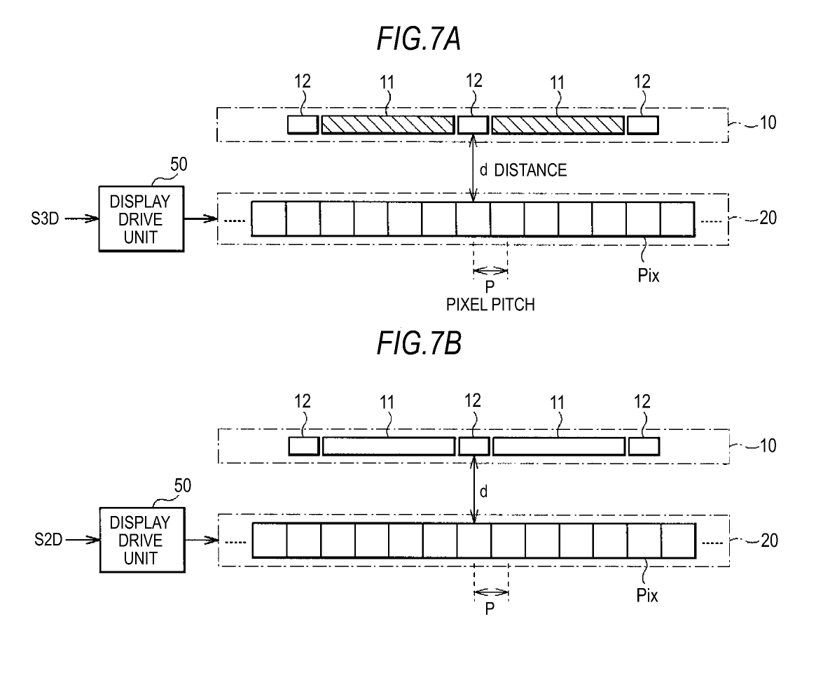

FIGS. 7A and 7B schematically show a state of the liquid-crystal barrier unit 10 in the case of performing stereoscopic display and normal display (two-dimensional display) by using a cross-sectional structure. FIG. 7A shows a state where the stereoscopic display is performed and FIG. 7B shows a state where the normal display is performed. As shown in FIGS. 7A and 7B, the display unit 20 and the liquid-crystal barrier unit 10 are arranged apart from each other by a distance “d”. In the display unit 20, the pixels Pix are arranged with a pixel pitch “P”. In the example, the open/close portions 12 are provided so that one open/close portion 12 corresponds to five pixels Pix in the display unit 20. The rate is not limited to this and it is also preferable that the open/close portions 12 are provided so that one open/close portion 12 corresponds to five sub-pixels SPix in the display unit 20. In FIGS. 7A and 7B, shaded open/close portions 11 represent a state where light is blocked.

When the stereoscopic display is performed, the open/close portions 12 are in the open state (transmitting state) and the open/close portions 11 are in the closed state (blocked state) in the liquid-crystal barrier unit 10 as shown in FIG. 7A. Then, the display drive unit 50 drives the display unit 20 based on the supplied video signal S3D and the display unit 20 displays pixel information corresponding to five viewpoint images included in the video signal S3D in five pixels pix adjacent to one another arranged at positions corresponding to the open/close portions 12 respectively as described later.

When the normal display (two-dimensional display) is performed, both the open/close portions 11 and 12 are in the open state (transmitting state) in the liquid-crystal barrier unit 10 as shown in FIG. 7B. The display drive unit 50 drives the display unit 20 based on the supplied video signal S2D and the display unit 20 displays one viewpoint image included in the video signal S2D as it is as described later.

In the 3D display device 1, the pitch (pitch in the horizontal direction shown in FIG. 6 (horizontal pitch “s”)) of the branch portions 63, the number of viewpoint images “n” (5 in this case), the pixel pitch P, the distance “d” and the like are set so as to given relational expressions. Accordingly, for example, when part of light bends at the open/close portions 12 in the open state, the image quality is not reduced as described later.

Here, the open/close portions 11 and 12 correspond to a specific example of “liquid crystal barriers” in the present disclosure. The liquid-crystal barrier unit 10 corresponds to a specific example of a “barrier unit” in the present disclosure. The branch portions 63 correspond to a specific example of “branch electrodes” in the present disclosure. The horizontal pitch “s” corresponds to a specific example of a “pitch s” in the present disclosure.

### [Operations and Actions]

Subsequently, operations and actions of the 3D display device 1 according to the embodiment will be explained.

### (Entire Operation Summary)

First, the entire operation summary of the 3D display device 1 will be explained with reference to FIG. 1. The control unit 41 supplies control signals to the display drive unit 50, the backlight control unit 42 and the barrier drive unit 43 respectively based on the video signal Sdisp supplied from the outside, thereby controlling these units to operate in synchronization with one another. The backlight drive unit 42 drives backlight 30 based on the backlight control signal CBL supplied from the control unit 41. The backlight 30 emits surface-emitted light to the display unit 20. The display control unit 50 drives the display unit 20 based on the video signal S supplied from the control unit 41. The display unit 20 performs display by modulating light emitted from the backlight 30. The barrier drive unit 43 drives the liquid-crystal barrier unit 10 based on the barrier control signal CBR supplied from the control unit 41. The open/close portions 11 and 12 of the liquid-crystal barrier unit 10 performs open/close operations based on an instruction from the barrier drive unit 43, transmitting or blocking light emitted from the backlight 30 and transmitted through the display unit 20.

### (Detailed Operations of Stereoscopic Display)

Next, detailed operations at the time of performing stereoscopic display will be explained with reference to some drawings.

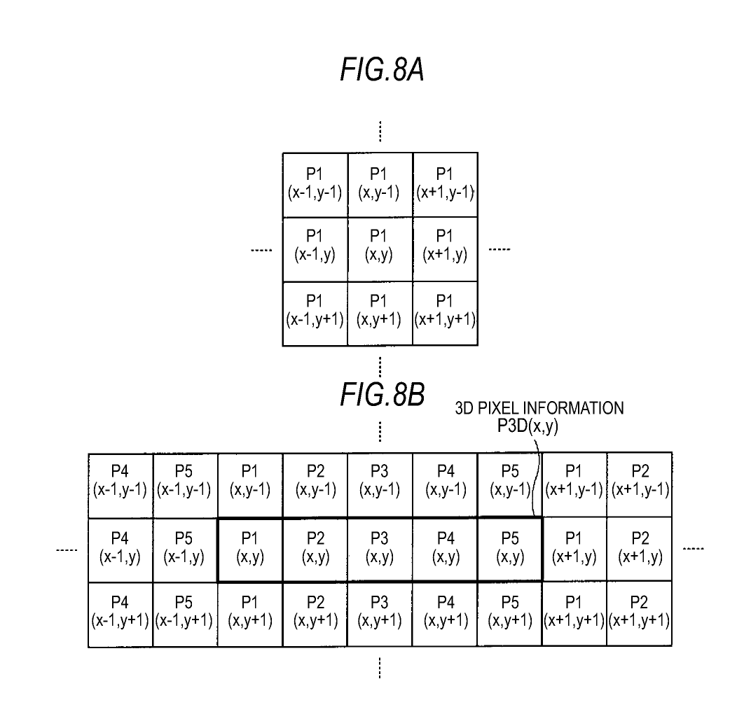

FIGS. 8A and 8B schematically show arrangement of pixel information. FIG. 8A shows arrangement of pixel information in each viewpoint image and FIG. 8B shows arrangement of pixel information in the video signal S3D. In FIG. 8A, arrangement of pixel information P1 in the first viewpoint image is shown as an example of the viewpoint image. Arrangements of pixel information P2 to P5 in the second to fifth viewpoint images are the same as FIG. 8A.

In the first viewpoint image, the pixel information P1 is arranged in the horizontal direction X and the vertical direction Y in a matrix state as shown in FIG. 8A. Specifically, in FIG. 8A, pixel information P1 (x−1, y) relating to coordinates (x−1, y) is arranged on the left side of pixel information P1 (x, y) relating to coordinates (x, y) and pixel information P1 (x+1, y) relating to coordinates (x+1, y) is arranged on the right side of the pixel information P1 (x, y).

In the video signal S3D, 3D pixel information P3D is arranged in the matrix state as shown in FIG. 8B. Here, the 3D pixel information P3D is information in which five types of pixel information is arranged side by side, which relates to the same coordinates in respective viewpoint images. Specifically, for example, in the 3D pixel information P3D (x, y) relating to coordinates (x, y), pixel information P1 (x, y), P2 (x, y), P3 (x, y), P4 (x, y) and P5 (x, y) relating to coordinates (x, y) in respective viewpoint images are arranged in this order as shown in FIG. 8B. In FIG. 8B, 3D pixel information P3D (x−1, y) is arranged on the left side of the 3D pixel information P3D (x, y) and 3D pixel information P3D (x+1, y) is arranged on the right side of the 3D pixel information P3D (x, y).

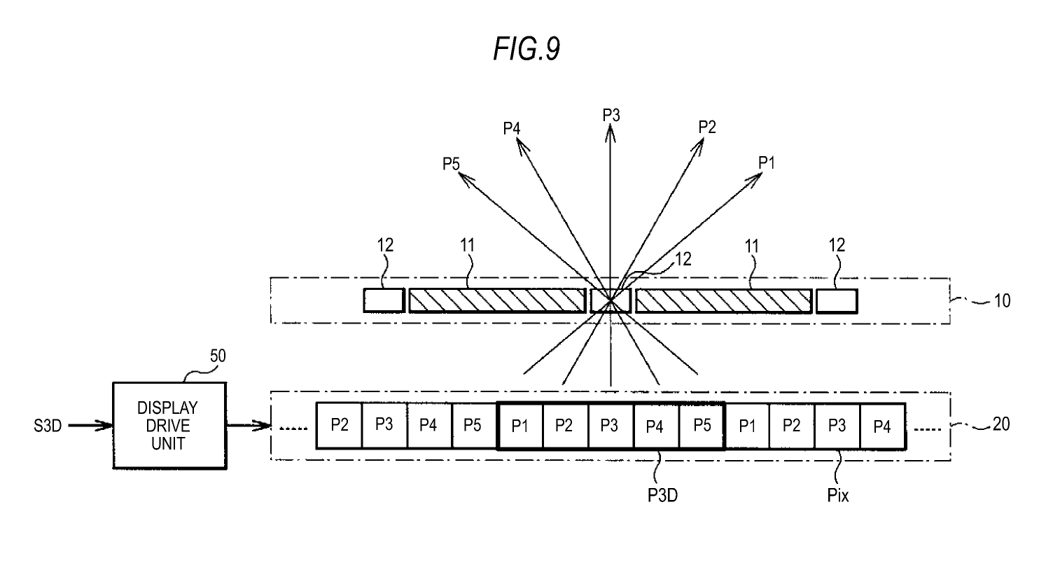

FIG. 9 shows an operation example of stereoscopic display in the display unit 20 and the liquid-crystal barrier unit 10. When stereoscopic display is performed, the open/close portions 12 become in the open state (transmitting state) as well as the open/close portions 11 become in the closed state (blocked state) in the liquid-crystal barrier unit 10. Then, the display unit 20 displays pixel information of the video signal S3D. At this time, five pixels Pix arranged in the vicinity of the open/close portion 12 displays 3D pixel information P3D as shown in FIG. 9. Light emitted from respective pixels Pix of the display unit 20 is outputted from the open/close portion 12 so that angles are controlled respectively. Accordingly, for example, the observer views pixel information P3 by the left eye and views pixel information P4 by the right eye. As the observer views different pixel information in the pixel information P1 to P5 by the left eye and the right eye in this manner, the observer can sense display video as stereoscopic video.

### (Bending of Light in Open/Close Portions 12)

When performing stereoscopic display, light emitted from the display unit 20 reaches the observer through the open/close portions 12 of the liquid-crystal barrier unit 10 in the open state. As the transparent electrodes 120 relating to the open/close portions 12 have plural branch portions 63 as shown in FIG. 6, light incident on the open/close portions 12 may bend due to, for example, diffraction or refraction. In the 3D display device 1, the observer rarely sense the reduction in image quality even when light bends at the open/close portions 12 as described above. The details will be explained below.

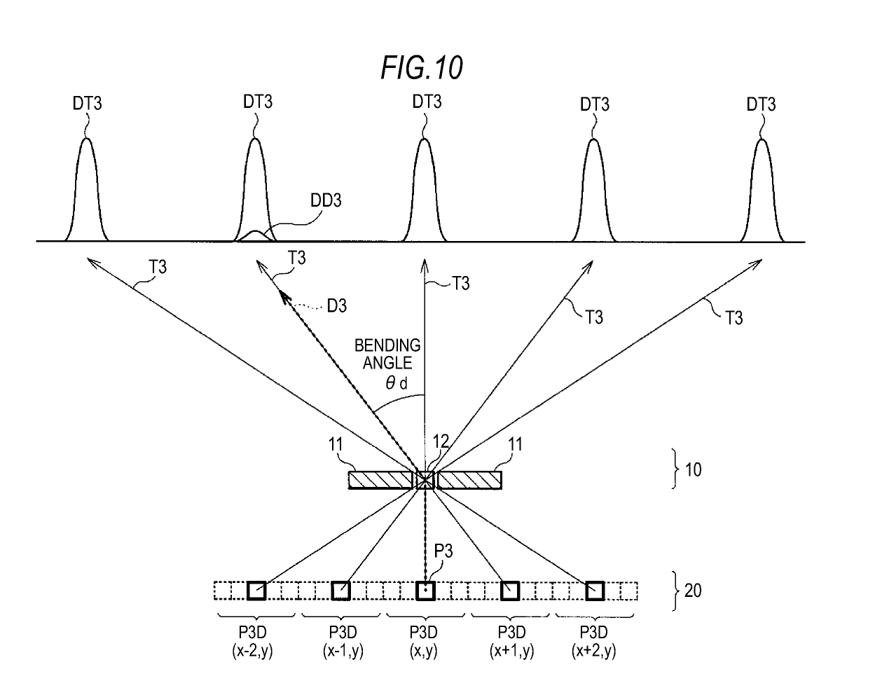

FIG. 10 schematically shows an example in which light bends at the open/close portion 12. FIG. 10 explains bending of light by using a cross-sectional view obtained by cutting the 3D display unit 1 at a surface including the horizontal direction of the 3D display device 1 and a normal direction of the display surface. That is, FIG. 10 explains a light traveling direction by being projected on the cross-section. In the example, the display unit 20 displays only the third viewpoint image (pixel information P3) in the five viewpoint images and the liquid-crystal barrier unit 10 allows only one open/close portion 12 to be in the transmitting state in plural open/close portions 12 for convenience of explanation.

Light relating to pixel information P3 displayed on the display unit 20 travels straight by being transmitted through the open/close portion 12 of the liquid-crystal barrier unit 10 in the open state. At this time, plural pixel information P3 displayed in pixels Pix which are different from one another in the display unit 20 travels straight toward respective directions through the open/close portion 12 as transmitted lights T3 corresponding to respective pixel information P3. Accordingly, transmitted light distributions DT3 as shown in FIG. 10 are respectively generated so as to correspond to traveling directions of respective transmitted lights T3.

On the other hand, light of the pixel information P3 emitted from the pixel Pix arranged in front of the open/close portion 12 bends at the open/close portion 12 and travels toward a direction of a bending angle θd as a bending light D3 as shown by a dashed line in FIG. 10. The bending angle θd can be represented by the following expression by using the horizontal pitch “s” (FIG. 6) of the branch portions 63 in the open/close portion 12.

θd=Sin⁻¹(λ/s) (1)

Here, λdenotes a light wavelength of the pixel information P3.

In the 3D display device 1, the traveling direction of the bending light D3 will be approximately the same as a traveling direction of the transmitted light T3 relating to another pixel information P3 concerning the same viewpoint image (the third viewpoint image). Specifically, in the example, the travelling direction of bending light D3 relating to the pixel information P3 of the 3D pixel information P3D (x, y) will be approximately the same as the traveling direction of the transmitted light T3 relating to pixel information P3 of 3D pixel information P3D (x+1, y) adjacent to the 3D pixel information P3D (x, y) as shown in FIG. 10. Accordingly, a bending light distribution DD3 based on the bending light D3 appears at a position corresponding to the transmitted light distribution DT3 as shown in FIG. 10. In the 3D display device 1, the bending light D3 and the transmitted light T3 traveling in approximately the same direction as the bending light D3 are generated from pixel information P3 different from each other in the same viewpoint image (the third viewpoint image).

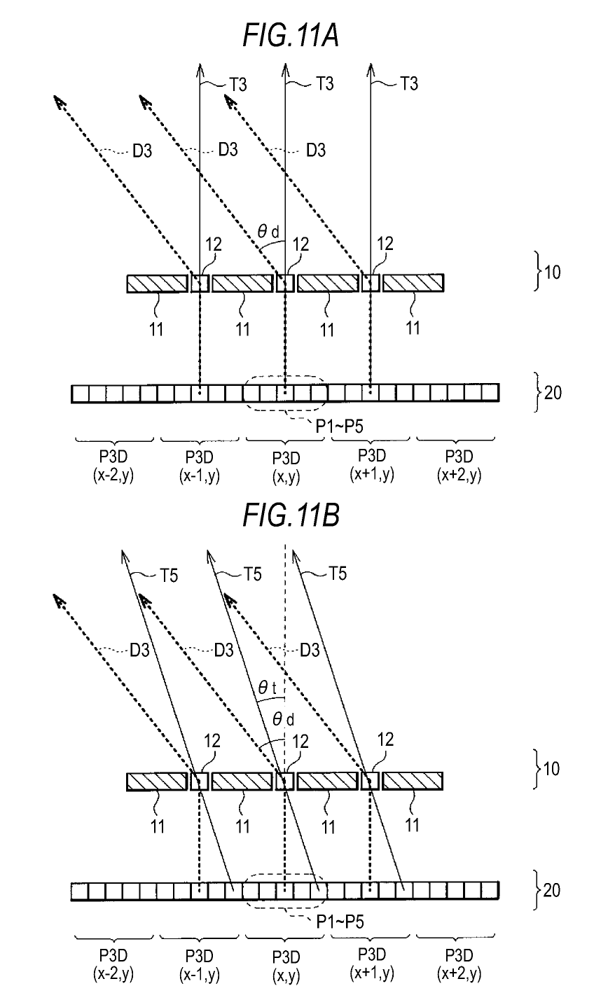

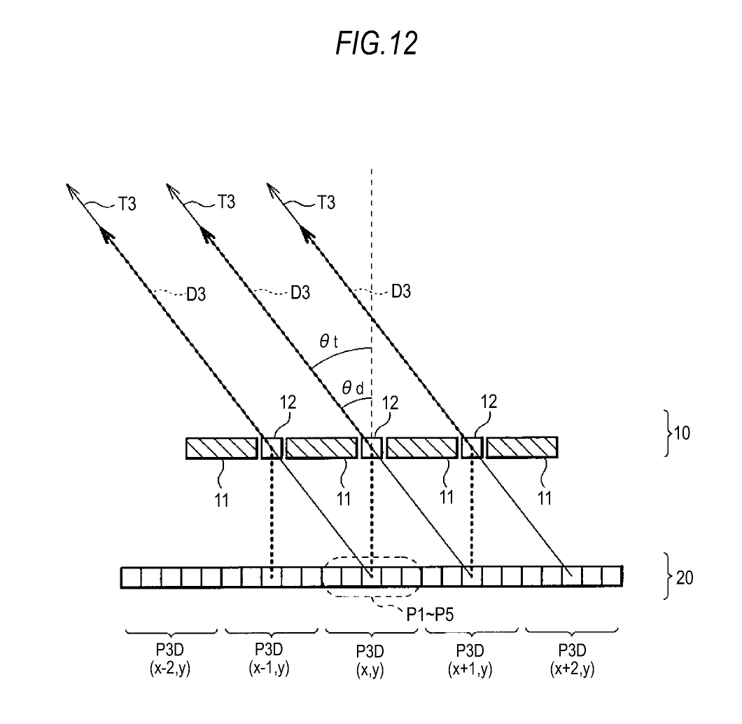

FIG. 11A schematically shows an operation example of the 3D display device 1 performed when the observer views the third viewpoint image and FIG. 11B schematically shows an operation example of the 3D display device 1 performed when the observer views the fifth viewpoint image. FIG. 12 schematically shows an operation example of the 3D display device 1 performed when the observer views the third viewpoint image from a direction shifted from the front of the display screen.

When the observer views the third viewpoint image, as shown in FIG. 11A, light relating to each pixel information P3 is transmitted through the open/close portion 12 arranged at a position corresponding to the pixel Pix which has emitted light and travels straight toward the normal direction of the display screen as the transmitted light T3 as well as part of the light is bent at the open/close portion 12 and travels toward a direction shifted from the normal direction of the display screen by the bending angle θd as the bending light D3. In this case, the traveling direction of the transmitted light T3 and the traveling direction of the bending light D3 are different from each other as shown in FIG. 11A, therefore, the observer who observes the display surface from the front observes only the transmitted lights T3 and does not observe the bending lights D3.

Similarly, when the observer views the fifth viewpoint image, light relating to each pixel information P5 is transmitted through the open/close portion 12 and travels straight toward the direction shifted from the normal direction of the display screen by a bending angle θt as a transmitted light T5 as shown in FIG. 11B. Part of the light relating to each pixel information P3 is bent at the open/close portion 12 and travels toward the directions shifted from the normal direction of the display screen by the bending angle θd as the bending light D3. Also in this case, the traveling direction of the transmitted light T5 and the traveling direction of the bending light D3 differ from each other as shown in FIG. 11B, therefore, the observer observes from the direction of the angle Δt observes only the transmitted lights T5 and does not observe the bending lights D3.

On the other hand, when the observer views the third viewpoint image from a position shifted from the front of the display screen as shown in FIG. 12, light relating to each pixel information P3 is not transmitted through the open/close portion 12 arranged in front of the pixel Pix which has emitted light but is transmitted through another open/close portion 12 adjacent to the open/close portion 12 and travels straight toward a direction shifted from the normal direction of the display screen by the angle Δt as the transmitted light T3. Part of light relating to each pixel information P3 is bent at the open/close portion 12 arranged at the position corresponding to the pixel Pix and travels toward the direction of the bending angle θd as the bending light D3. At this time, the traveling direction of the transmitted light T3 and the traveling direction of the bending light D3 are approximately the same. That is, the bending angle θd is represented by the following expression.

θd˜θt (2)

In other words, the horizontal pitch “s” of the branch portions 63 in the liquid-crystal barrier unit 10 satisfies the following expression derived from the expressions (1) and (2).

Sin⁻¹(λ/s)˜θt (A)

Accordingly, the observer making observation from the direction of the angle Δt views both the transmitted lights T3 and the bending lights D3. Here, the pixel information P3 relating to the transmitted light T3 and the pixel information P3 relating to the bending light D3 are displayed on the pixels Pix different from one another, which belong to the same viewpoint image (the third viewpoint image) as described above. That is, the pixel information P3 relating to the transmitted light T3 and the pixel information P3 relating to the bending light D3 belong to the same viewpoint image, not different viewpoint images even when, for example, the intensity of light of the bending light D3 is in a considerable level as compared with the transmitted light T3, therefore, it is possible to reduce the risk of occurrence of so-called crosstalk, in which different viewpoint images are mixed as described later in comparison with a comparative example.

The angle Δt can be represented by the following expression by using the pixel pitch P and the distance “d”.

θt=Tan⁻¹(n·P/d) (3)

Here, “n” denotes the number of viewpoint images, which is five in this example. Accordingly, the θd of the bending light D3 satisfies the following expression according to the expressions (2) and (3) in the 3D display device 1.

θd˜Tan⁻¹(n·P/d) (4)

In other words, the horizontal pitch “s” satisfies the following expression derived from the expressions (A) and (3).

Sin⁻¹(λ/s)˜Tan⁻¹(n·P/d) (5)

In the case shown in FIG. 12, as the pixel information P3 relating to the transmitted light T3 and the pixel information P3 relating to the bending light D3 are displayed on the pixels Pix different from each other, the plural same images may be displayed at shifted display positions. In that case, the observer sees so-called ghosts in the displayed video. However, the pixel information to be mixed is information (pixel information P3) belonging to the same viewpoint image (the third viewpoint image) in 3D pixel information P3D adjacent to each other as shown in FIG. 12, therefore, the shifted amount in the displayed video is small and image quality does not deteriorate so much. As a main factor of deterioration in image quality occurring when performing stereoscopic display is the crosstalk, it is important how to suppress the crosstalk. Therefore, the 3D display device 1 can be applied to a case where the deterioration in image quality due to ghosts is not so serious.

As described above, in the 3D display device 1, the bending lights D3 and the transmitted lights T3 relating to pixel information P3 different from one another in the same viewpoint image travel in approximately the same direction. Here, it is not always necessary that the traveling direction of the bending lights D3 and the traveling direction of the transmitted lights T3 are completely the same. The relation between the traveling direction of the bending lights D3 and the traveling direction of the transmitted lights T3 will be explained below.

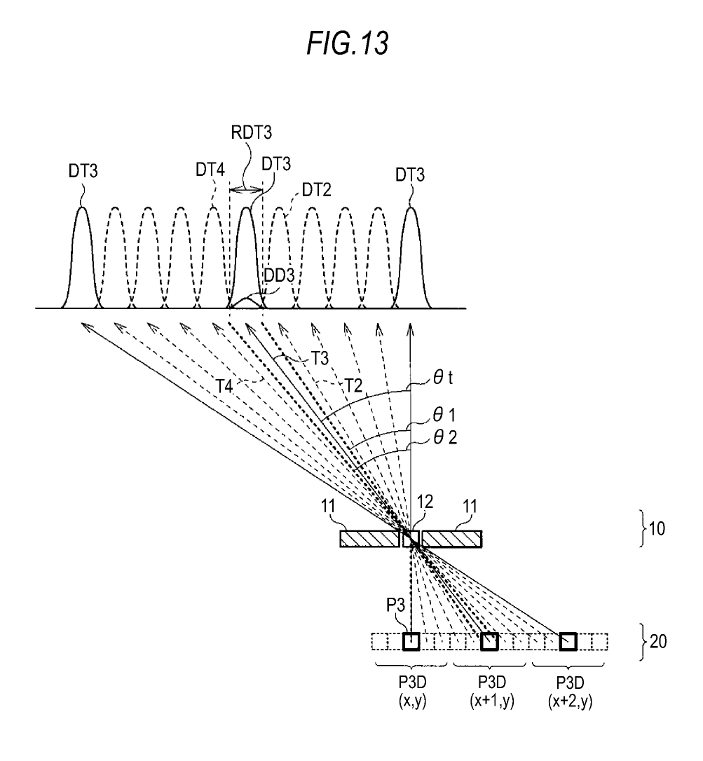

FIG. 13 shows an allowable range of the traveling direction of the bending lights D3. In the example, the display unit 20 displays only the third viewpoint image (pixel information P3) in the five viewpoint images and the liquid-crystal barrier unit 10 allows only one open/close portion 12 in plural open/close portions 12 to be in the transmitting state for convenience of explanation.

As described above, when light relating to the pixel information P3 belonging to the third viewpoint image is bent in the open/close unit 12, it is desirable that the traveling direction of the bending light D3 approximately correspond to the traveling direction of the transmitted light T3 from the viewpoint of crosstalk. In other words, it is necessary that the traveling direction of the bending light D3 differs from traveling directions of transmitted lights T1, T2, T4 and T5 of pixel information P1, P2, P4 and P5 belonging to viewpoint images other than the third viewpoint image. Specifically, it is necessary that the bending light D3 travels within a range of a range RDT3 of the transmitted light distribution DT3 relating to the transmitted light 13 as shown in FIG. 13. Here, the range RDT3 is a range from a boundary between a transmitted light distribution DT2 and the transmitted light distribution DT3 to a boundary between the transmitted light distribution DT3 and a transmitted light distribution DT4. That is, it is necessary that the bending angle θd of the bending light D3 satisfies the following expression.

θ1≦d≦θ2 (6)

In other words, it is necessary that the horizontal pitch “s” satisfies the following expression derived from the expressions (1) and (6).

θ1≦Sin⁻¹(λ/s)≦θ2 (B)

Here, θ1 is an angle corresponding to the boundary between the transmitted light distribution DT2 and the and the transmitted light distribution DT3, and θ2 is an angle corresponding to the boundary between the transmitted light distribution DT3 and the transmitted light distribution DT4. Specifically, the angles θ1 and θ2 are represented by the following expressions.

θ1=Tan⁻¹((n−1/2)·P/d) (7)

θ2=Tan⁻¹((n−1/2)·P/d) (8)

An expression to be satisfied by the bending angle θd of the bending light D3 according to the expressions (6), (7) and (8) is as follows.

Tan⁻¹((n−1/2)·P/d)≦θd≦Tan⁻¹((n+1/2)·P/d) (9)

In other words, it is necessary that the horizontal pitch “s” satisfies the following expression derived from the expressions (1) and (9).

Tan⁻¹((n−1/2)·P/d)≦Sin⁻¹(λ/s)≦Tan⁻¹((n+1/2)·P/d) (10)

As described above, when the number of viewpoints “n”, the pixel pitch P, the distance “d”, the horizontal pitch “s” and the wavelength λ satisfy the expressions (10) in the 3D display unit 1, the traveling direction of the bending light D3 can be the same as the traveling direction of the transmitted light T3, which reduces the risk of deterioration in image quality due to crosstalk.

### Comparative Example

Next, actions of the embodiment will be explained in comparison with a comparative example. In a 3D display device 1R according to the comparative example, the number of viewpoints “n”, the pixel pitch P, the distance “d”, the horizontal pitch “s” and the wavelength λ do not satisfy the expression (10).

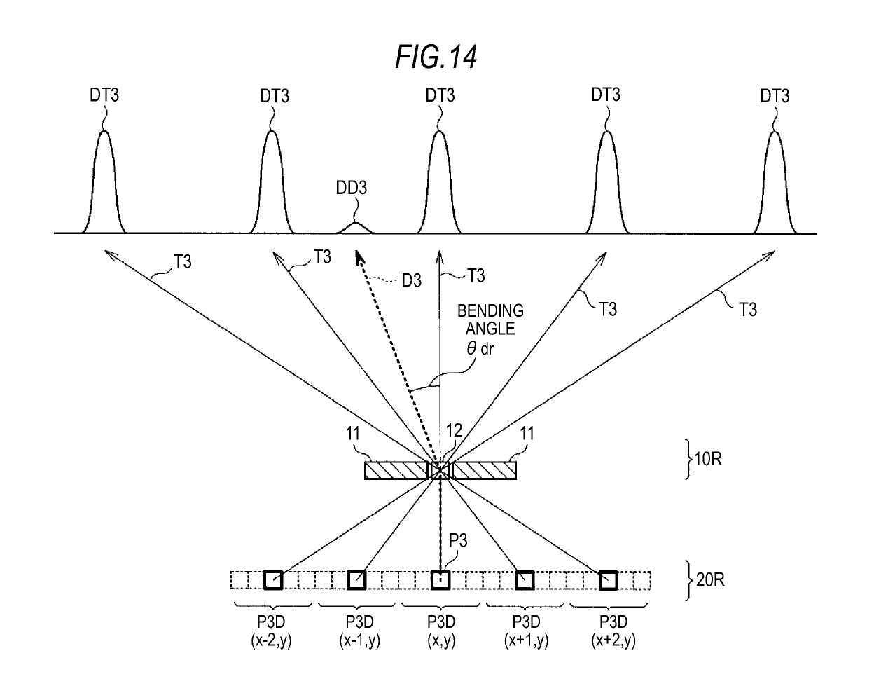

FIG. 14 schematically shows an example in which light bends in the 3D display device 1R. In the example, light of each pixel information P3 bends at the open/close portion 12 and travels towards the direction shifted from the normal direction of the display screen by a bending angle θdr as the bending light D3. At this time, the bending light D3 travels in the direction different from the traveling directions of the transmitted lights T3 in the 3D display device 1R as shown in FIG. 14. Accordingly, a bending light distribution DD3 appears between transmitted light distributions DT3 as shown in FIG. 14.

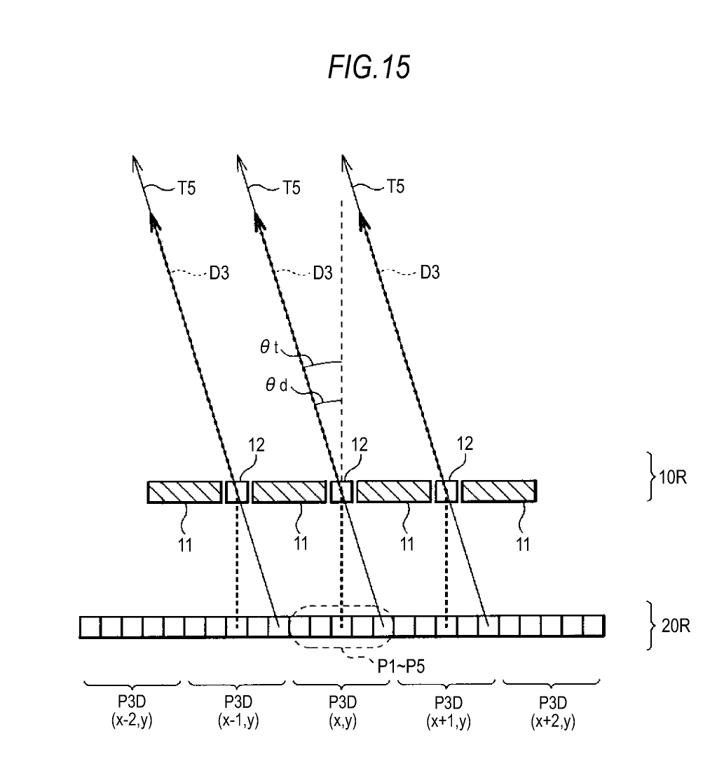

FIG. 15 schematically shows an operation example of the 3D display device 1R performed when the observer views the fifth viewpoint image. As shown in FIG. 15, light relating to respective pixel information P5 travels straight toward directions shifted from the normal direction of the display screen by an angle θtr through the open/close portions 12 as transmitted lights T5 as shown in FIG. 15. In the example, the bending angle θdr and the angle θtr are equal to each other. That is, the traveling directions of the bending lights D3 of the pixel information P3 belonging to the third viewpoint image is equal to the traveling directions of the transmitted lights T5 of pixel information P5 belonging to the fifth viewpoint image. At this time, the observer making observation from the direction of the angle θt observes the bending lights D3 and the transmitted lights T5 at the same time. That is, the third viewpoint image and the fifth viewpoint image which are different viewpoint images with a large shifted amount are displayed in a mixed state in the 3D display device 1R. Accordingly, as the observer observes an image in which different viewpoint images are mixed in the 3D display device 1R, the observer is in danger of feeling deterioration in image quality due to the crosstalk because the observer observes the image in which different viewpoint images are mixed.

On the other hand, in the 3D display device 1 according to the embodiment, the traveling direction of the bending lights D3 of the pixel information P3 belonging to the third viewpoint image is approximately equal to the traveling direction of the transmitted lights T3 of the pixel information P3 belonging to the same third viewpoint image. That is, the pixel information P3 relating the transmitted lights T3 and the pixel information P3 relating the bending lights D3 belong to the same viewpoint image, not different viewpoint images, therefore, the risk of generating crosstalk can be reduced.

### [Advantages]

As described above, the bending light and the transmitted light traveling in approximately the same direction as the bending light are generated from pixel information different to each other in the same viewpoint image in the embodiment, therefore, it is possible to reduce the crosstalk and suppress deterioration in image quality.

### Modification Example 1-1

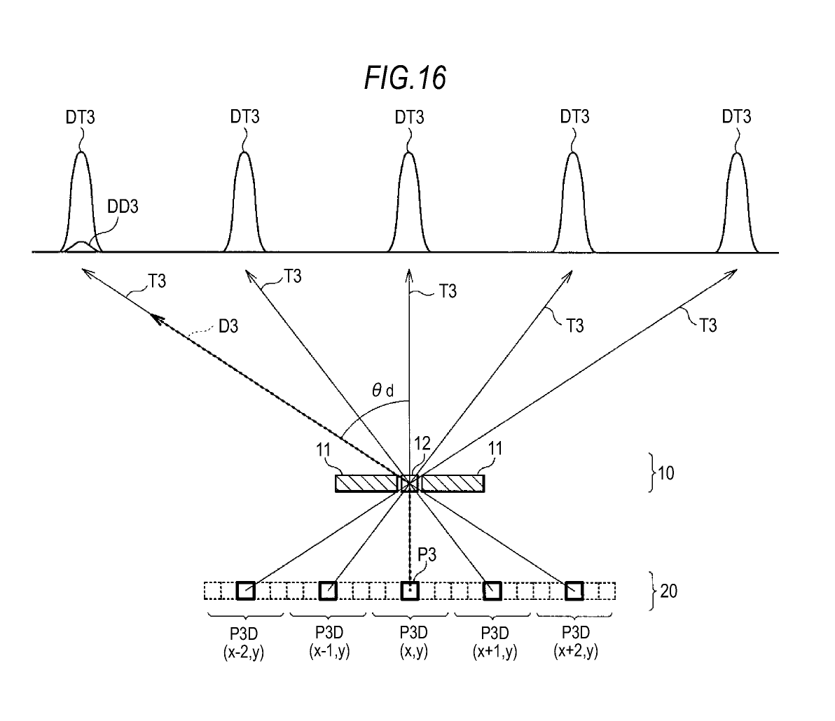

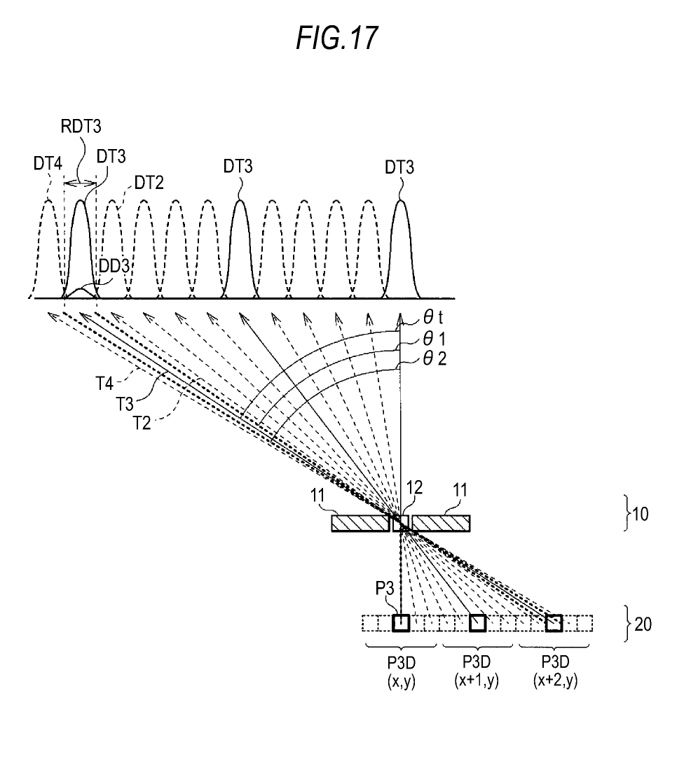

In the above embodiment, the traveling direction of the bending light D3 relating to the pixel information P3 of the 3D pixel information P3D (x, y) is approximately the same as the traveling direction of the transmitted light T3 relating to the pixel information P3 of the 3D pixel information P3D (x+1, y) adjacent to the 3D pixel information P3D (x, y) as shown in FIG. 10, however, it is not limited to the above. It is also preferable, instead of the above, for example, that the traveling direction of the bending light D3 relating to the pixel information P3 of the pixel information P3 of the 3D pixel information P3D (x, y) is approximately the same as a traveling direction of the transmitted light T3 relating to the pixel information P3 of the 3D pixel information P3D (x+2, y) which is two pixels adjacent to the 3D pixel information P3D (x, y) as shown in FIG. 16 and FIG. 17. In this case, the angles θ1 and θ2 are represented by the following expressions.

θ1=Tan⁻¹((2·n−1/2)·P/d) (11)

θ2=Tan⁻¹((2·n−1/2)·P/d) (12)

Also in this case, it is possible to reduce crosstalk and to suppress deterioration in image quality in the same manner as the above embodiment.

The present disclosure has been explained by citing the embodiment and some modification examples, and the present disclosure is not limited to the embodiment and so on and can be variously modified.

For example, the open/close portions 12 are constantly in the open state when performing the stereoscopic display in the above embodiment and so on, however, the present disclosure is not limited to the above. It is also preferable, instead of the above, for example, that the open/close portions 12 are divided into plural groups to perform open/close operations in a time division manner in respective groups. For example, when the open/close portions 12 are divided into two groups and open/close operations are alternately performed between the groups, resolution of the 3D display device can be doubled.

Also in the above embodiment, the 3D display device displays five viewpoint images when performing stereoscopic display, however, the present disclosure is not limited to the above. For example, it is also preferable, instead of the above, that the 3D display device displays six or more viewpoint images or four or less viewpoint images.

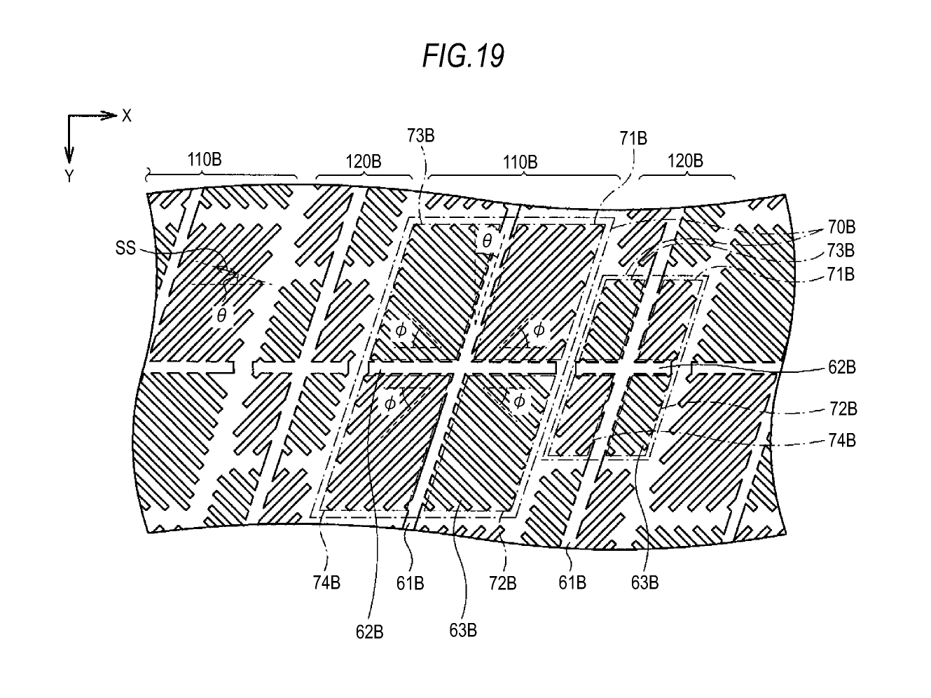

Also in the above embodiment, the open/close portions 11 and 12 are formed so as to extend in the Y-direction, however, the present disclosure is not limited to the above. It is also preferable, instead of the above, for example, that the open/close portions 11 and 12 are formed so as to extend in a direction so as to make a given angle θ from the vertical direction Y. The angle θ can be set, for example, to 18 degrees. In this case, the transparent electrode layer 312 can be formed, for example, as shown in FIG. 19. In this case, a pitch “ss” of blanch portions 63B (FIG. 19) in a direction vertical to the extending direction of the open/close portions 11 and 12 is used instead of the horizontal pitch “s” in the above embodiment. When FIG. 10 to FIG. 13 in the above embodiment are applied to the modification example, these drawings should be interpreted as explained by using a cross-sectional view obtained by cutting the device at a surface including the direction orthogonal to the extending direction of the open/close portions 11 and 12 and the normal direction of the display surface.

The present disclosure may be implemented as the following configurations.

(1) A display device including

a display unit respectively displaying respective pixel information of plural viewpoint images different from one another by arranging the pixel information in a circulating order in the plural viewpoint images on a display surface, and

a barrier unit having plural liquid crystal barriers capable of being switched between an open state and a closed state, extending in a first direction as well as arranged side by side in a second direction intersecting the first direction, in which each barrier includes plural branch electrodes arranged side by side,

in which a pitch “s” of the branch electrodes in the second direction satisfies the following expression (A):

Sin⁻¹(λ/s)˜θt (A)

note that λ denotes a light wavelength transmitted through one liquid crystal barrier in the open state, and

θt denotes an angle between a line connecting one pixel arranged at a position corresponding to another liquid crystal barrier which is different from the one liquid crystal barrier in plural liquid crystal barriers in the open state to the one liquid crystal barrier and a normal direction of the display surface in a plane including the second direction and the normal direction.

(2) The display device described in the above (1),

in which the one liquid crystal barrier is adjacent to another liquid crystal barrier in plural liquid crystal barriers in the open state.

(3) The display device described in the above (1),

in which the pitch “s” satisfies the following expression (B)

θ1≦Sin⁻¹(λ/s)≦θ2 (B)

note that θ1 is an angle between a line connecting one boundary portion in the second direction in boundary portions between the one pixel and adjacent pixels to the one liquid crystal barrier and the normal direction, and

θ2 is an angle between a line connecting the other boundary portion of the one pixel in the second direction to the one liquid crystal barrier and the normal direction.

(4) The display device described in any of the above (1) to (3),

in which the first direction and the second direction are orthogonal to each other.

(5) The display device described in any of the above (1) to (4),

in which the barrier unit has plural liquid crystal barriers of a first series and plural liquid crystal barriers of a second series.

(6) The display device described in the above (5),

in which plural display modes including a 3D video display mode and a 2D video display mode are included, and

in the 3D video display mode, the display unit displays the plural viewpoint images and the plural liquid crystal barriers of the first series are in a transmitting state as well as the plural liquid crystal barriers of the second series are in a blocked state to thereby display 3D video.

(7) The display device described in the above (6),

in which the plural liquid crystal barriers of the first series are divided into plural barrier groups, and

in the 3D video display mode, the plural liquid crystal barriers of the first series are switched between the open state and the closed state in a time division manner in respective barrier groups.

(8) The display device described in any of the above (5) to (7),

in which plural display modes including a 3D video display mode and a 2D video display mode are included,

in the 2D video display mode, the display unit displays one viewpoint image, and the plural liquid crystal barriers of the first series and the plural liquid crystal barriers of the second series are in the transmitting state to thereby display 2D video.

(9) The display device described in any of the above (5) to (8), further including

a backlight,

in which the display unit is a liquid crystal display unit, and

the liquid crystal display unit is disposed between the backlight and the barrier unit.

(10) A display device including

a display unit respectively displaying respective pixel information of plural viewpoint images different from one another by arranging the pixel information in a circulating order in the plural viewpoint images on a display surface, and

a barrier unit in which plural transmitting portions which transmits light and plural blocking portions which blocks light are arranged side by side,

in which light relating to one viewpoint image in the plural viewpoint images which is a first light emitted from a pixel arranged at a position corresponding to one transmitting portion in the plural transmitting portions and transmitted through the one transmitting portion bends along a direction in which a second light relating to the one viewpoint image travels straight, which is emitted from a pixel arranged at a position corresponding to another transmitting portion which is different from the one transmitting portion in the plural transmitting portions and traveling straight through the one transmitting portion.

(11) The display device described in the above (10),

in which the one transmitting portion is adjacent to another transmitting portion.

The present disclosure contains subject matter related to that disclosed in Japanese Priority Patent Application JP 2011-160223 filed in the Japan Patent Office on Jul. 21, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display unit respectively displaying respective pixel information of plural viewpoint images different from one another by arranging the pixel information in a circulating order in the plural viewpoint images on a display surface; and
a barrier unit having plural liquid crystal barriers capable of being switched between an open state and a closed state, extending in a first direction as well as arranged side by side in a second direction intersecting the first direction, in which each barrier includes plural branch electrodes arranged side by side,
wherein a pitch “s” of the branch electrodes in the second direction satisfies the following expression (A)
Sin⁻¹(λ/s)˜θt (A)
note that λ denotes a light wavelength transmitted through one liquid crystal barrier in the open state, and
θt denotes an angle between a line connecting one pixel arranged at a position corresponding to another liquid crystal barrier which is different from the one liquid crystal barrier in plural liquid crystal barriers in the open state to the one liquid crystal barrier and a normal direction of the display surface in a plane including the second direction and the normal direction.

2. The display device according to claim 1,
wherein the one liquid crystal barrier is adjacent to another liquid crystal barrier in plural liquid crystal barriers in the open state.

3. The display device according to claim 1,
wherein the pitch “s” satisfies the following expression (B)
θ1≦Sin⁻¹(λ/s)≦θ2 (B)
note that θ1 is an angle between a line connecting one boundary portion in the second direction in boundary portions between the one pixel and adjacent pixels to the one liquid crystal barrier and the normal direction, and
θ2 is an angle between a line connecting the other boundary portion of the one pixel in the second direction to the one liquid crystal barrier and the normal direction.

4. The display device according to claim 1,
wherein the first direction and the second direction are orthogonal to each other.

5. The display device described according to claim 1,
wherein the barrier unit has plural liquid crystal barriers of a first series and plural liquid crystal barriers of a second series.

6. The display device according to claim 5,
wherein plural display modes including a 3D video display mode and a 2D video display mode are included, and
in the 3D video display mode, the display unit displays the plural viewpoint images and the plural liquid crystal barriers of the first series are in a transmitting state as well as the plural liquid crystal barriers of the second series are in a blocked state to thereby display 3D video.

7. The display device according to claim 6,
wherein the plural liquid crystal barriers of the first series are divided into plural barrier groups, and
in the 3D video display mode, the plural liquid crystal barriers of the first series are switched between the open state and the closed state in a time division manner in respective barrier groups.

8. The display device according to claim 5,
wherein plural display modes including a 3D video display mode and a 2D video display mode are included,
in the 2D video display mode, the display unit displays one viewpoint image, and the plural liquid crystal barriers of the first series and the plural liquid crystal barriers of the second series are in the transmitting state to thereby display 2D video.

9. The display device according to claim 1, further comprising:
a backlight,
wherein the display unit is a liquid crystal display unit, and
the liquid crystal display unit is disposed between the backlight and the barrier unit.

10. A display device comprising:
a display unit respectively displaying respective pixel information of plural viewpoint images different from one another by arranging the pixel information in a circulating order in the plural viewpoint images on a display surface; and
a barrier unit in which plural transmitting portions which transmits light and plural blocking portions which blocks light are arranged side by side,
wherein light relating to one viewpoint image in the plural viewpoint images which is a first light emitted from a pixel arranged at a position corresponding to one transmitting portion in the plural transmitting portions and transmitted through the one transmitting portion bends along a direction in which a second light relating to the one viewpoint image travels straight, which is emitted from a pixel arranged at a position corresponding to another transmitting portion which is different from the one transmitting portion in the plural transmitting portions and traveling straight through the one transmitting portion.

11. The display device according to claim 10,
wherein the one transmitting portion is adjacent to another transmitting portion.
